(19) United States
(12) Patent Application Publication
(10) Pub. No.: US 2025/0096251 A1
(43) Pub. Date: Mar. 20, 2025

(54) ELECTRODE FOR LITHIUM METAL BATTERY INCLUDING SILICA LAYER CONTAINING PLATE-LIKE POROUS SILICA AND LITHIUM METAL BATTERY INCLUDING THE SAME

(71) Applicant: Daegu Gyeongbuk Institute of Science and Technology, Dalseong-gun (KR)

(72) Inventors: Jong-Sung YU, Seoul (KR); Jong Hun SUNG, Gyeongsangnam-do (KR)

(73) Assignee: Daegu Gyeongbuk Institute of Science and Technology, Dalseong-gun (KR)

(21) Appl. No.: 18/811,314

(22) Filed: Aug. 21, 2024

(30) Foreign Application Priority Data
Sep. 19, 2023 (KR) 10-2023-0124484

(51) Int. Cl. H01M 4/48; H01M 4/02; H01M 4/04; H01M 4/36; H01M 10/052

(52) U.S. Cl. CPC H01M 4/48; H01M 4/0404; H01M 4/045; H01M 4/366; H01M 10/052; H01M 2004/021; H01M 2004/027

(57) ABSTRACT

The present disclosure relates to an electrode for a lithium metal battery, the electrode including: a current collector; and a silica layer containing plate-like porous silica, wherein pores of the plate-like porous silica have a cylindrical structure, and a lithium metal battery including the same. The formation of lithium dendrites on a surface of a negative electrode is prevented, such that stability of the battery may be improved and long-term cycle performance and rate capability may be improved.

### CROSS-REFERENCE TO RELATED APPLICATIONS

This application claims priority under 35 U.S.C. § 119 to Korean Patent Application No. 10-2023-0124484, filed on Sep. 19, 2023, in the Korean Intellectual Property Office, the disclosure of which is incorporated herein by reference in its entirety.

### TECHNICAL FIELD

The following disclosure relates to an electrode for a lithium metal battery including a silica layer containing plate-like porous silica and a lithium metal battery including the same.

### BACKGROUND

A lithium metal battery (Li metal battery, LMB), which has a significantly higher energy density than a lithium ion battery (Li ion battery, LIB), is emerging as a promising next-generation energy storage system. However, the lithium metal battery has a problem with the formation of lithium dendrites on a surface of a negative electrode. When the dendrite structures grow on the surface of the negative electrode, a contact area between a current collector and lithium may be reduced. In addition, lithium and an electrolyte are excessively consumed, resulting in a reduction in coulombic efficiency and occurrence of serious losses in capacity and energy density. Accordingly, there are problems not only in deterioration of battery performance but also in deterioration of safety, durability, and lifespan of the battery, which is a major impediment to commercialization.

In order to solve these problems, research on a method for stably depositing a lithium metal by introducing a functional material onto a surface of a negative electrode current collector has been actively conducted. Typically, the functional material may include transition metal oxides such as silica (SiO₂), titanium dioxide (TiO₂), and alumina (Al₂O₃). These oxides have the advantage of helping stable deposition of the lithium metal because they have a polarity and are lithium-friendly. However, since these transition metal oxides are inert materials that do not affect the capacity of the battery, as weights and volumes of the inert materials included in the battery increase, the capacity and energy density per volume or weight of the battery decrease. In addition, these oxides usually have a low electrical conductivity that is close to that of an insulator, which is a major obstacle to being used as an electrode material.

Accordingly, there is an urgent need for research and development on a functional material that may improve rate capability and cycle performance of a lithium metal battery by suppressing the formation of lithium dendrites, and at the same time, may minimize reductions in capacity and energy density of the battery by reducing a weight and volume of an inert material.

### SUMMARY

An embodiment of the present disclosure is directed to providing an electrode for a lithium metal battery that may prevent the formation of lithium dendrites.

Another embodiment of the present disclosure is directed to providing a lithium metal battery having improved long-term cycle performance and improved rate capability.

Still another embodiment of the present disclosure is directed to minimizing a loss in energy density in a battery by reducing a weight and volume of a functional material used to suppress the formation of lithium dendrites.

In one general aspect, an electrode for a lithium metal battery includes: a current collector; and a silica layer located on the current collector and containing plate-like porous silica, wherein pores of the plate-like porous silica have a cylindrical structure.

In an exemplary embodiment, the silica layer may be obtained by stacking a plurality of plate-like porous silica.

In an exemplary embodiment, the plate-like porous silica may have cylindrical mesopores having a diameter of 2 nm to 50 nm.

In an exemplary embodiment, a ratio (V₁/V₂) of a mesopore volume (V₁) to a micropore volume (V₂) in the plate-like porous silica may be 50 to 200.

In an exemplary embodiment, an average pore size of the cylindrical pores included in the plate-like porous silica may be 4 nm to 20 nm.

In an exemplary embodiment, a length of the cylindrical pore included in the plate-like porous silica may be 30 nm to 1,000 nm.

In an exemplary embodiment, the plate-like porous silica may have a hexagonal platelet structure.

In an exemplary embodiment, a width of a pore size distribution ((D₉₀−D₁₀)/D₅₀) of the pores included in the plate-like porous silica may be 0.8 to 1.2.

In an exemplary embodiment, the electrode for a lithium metal battery may further include a lithium metal contained in the silica layer.

In an exemplary embodiment, the lithium metal may be deposited by an electrochemical method.

In an exemplary embodiment, the silica layer may further contain a binder.

In another general aspect, a lithium metal battery includes the electrode for a lithium metal battery.

The lithium metal battery according to the present disclosure includes: a negative electrode including the electrode for a lithium metal battery; a positive electrode disposed to face the negative electrode and to be spaced apart from the negative electrode; and an electrolyte filled between the negative electrode and the positive electrode.

In an exemplary embodiment, the lithium metal battery may further include a separator interposed between the positive electrode and the negative electrode.

Other features and aspects will be apparent from the following detailed description, the drawings, and the claims.

### BRIEF DESCRIPTION OF THE DRAWINGS

FIG. 1A is a scanning transmission electron microscope (STEM) image of platelet ordered mesoporous silica (pOMS).

FIGS. 1B and 1C are EDS mapping images of pOMS.

FIG. 1D is a scanning transmission electron microscope (STEM) image of platelet ordered mesoporous carbon (pOMC).

FIG. 1E is an EDS mapping image of pOMC.

FIGS. 2A and 2B are transmission electron microscope (TEM) images of pOMS and pOMC, respectively.

FIG. 3A is a graph showing nitrogen adsorption isotherms of pOMS and pOMC.

FIG. 3B is a graph showing pore size distributions of pOMS and pOMC.

FIGS. 4A to 4C are graphs obtained by measuring overpotential according to current densities of Li∥Cu batteries including electrodes for a lithium metal battery according to Example 1, Comparative Example 1, and Comparative Example 2, respectively.

FIGS. 5A to 5C are scanning electron microscope (SEM) images obtained by observing cross sections of the electrodes for a lithium metal battery of Example 1, Comparative Example 1, and Comparative Example 2 before and after lithium deposition, respectively.

FIG. 6 is a schematic diagram showing lithium deposition behavior of the electrodes for a lithium metal battery according to Example 1 and Comparative Example 2.

FIGS. 7A to 7H are graphs obtained by measuring cycle performance according to current densities of Li∥Li symmetric batteries including the electrodes for a lithium metal battery according to Example 1, Comparative Example 1, and Comparative Example 2, respectively.

FIGS. 8A and 8B are graphs obtained by measuring cycle performance of full cells including the electrodes for a lithium metal battery according to Example 1, Comparative Example 1, and Comparative Example 2, respectively.

FIG. 8C is a graph obtained by measuring rate capability of the full cells including the electrodes for a lithium metal battery according to Example 1, Comparative Example 1, and Comparative Example 2.

FIG. 8D is a graph obtained by measuring self-discharge behavior of the full cells including the electrodes for a lithium metal battery according to Example 1 and Comparative Example 2.

### DETAILED DESCRIPTION OF EMBODIMENTS

An electrode for a lithium metal battery including a silica layer containing plate-like porous silica of the present disclosure and a lithium metal battery including the same will be described in detail. General terms that are currently widely used are selected as terms used in the present specification in consideration of functions in the present disclosure, but may be changed depending on the intention of those skilled in the art or a judicial precedent, the emergence of a new technique, and the like. Unless otherwise defined, all the technical terms and scientific terms used herein may have the same meanings as commonly understood by those skilled in the art to which the present disclosure pertains.

The terms “comprise(s)”, “include(s)”, “have (has)”, and the like used in the present specification and the scope of the appended claims indicate the presence of features or components described in the specification, and do not preclude the presence or addition of one or more other features or components, unless specifically limited.

The terms “first”, “second”, and the like in the present specification and the scope of the appended claims are not used as limiting meanings, but are used to distinguish one component from another component.

Unless the context clearly indicates otherwise, the singular forms used in the present specification and the appended claims are intended to include the plural forms. In addition, unless the context clearly indicates otherwise, the plural forms are intended to include the singular forms.

In addition, a numerical range used in the present specification includes upper and lower limits and all values within these limits, increments logically derived from a form and span of a defined range, all double limited values, and all possible combinations of the upper and lower limits in the numerical range defined in different forms. Unless otherwise specifically defined in the specification of the present disclosure, values out of the numerical range that may occur due to experimental errors or rounded values also fall within the defined numerical range.

The terms “about” and the like used in the present specification and the appended claims are used to encompass existing tolerances.

Silica is not only inexpensive and easily processed, but also has a high affinity for lithium. Therefore, research has been actively conducted to stably deposit a lithium metal by introducing a functional layer containing silica onto a surface of an electrode current collector of a lithium metal battery. However, silica is unstable in high-speed charging and discharging because its insulating properties cause high resistance at a high current density. In addition, silica is an inert material that does not react directly with lithium, and thus does not contribute to improving a battery capacity. As the use of the inert material increases a volume and weight of an electrode, an energy density per weight and volume of the battery decreases, which may cause deterioration of battery performance.

Accordingly, the present applicant has developed an electrode for a lithium metal battery that may minimize a reduction in energy density of the battery because the form of a lithium metal deposited on the electrode during repeated charging and discharging is controlled by introducing a silica layer containing plate-like porous silica having precisely controlled pore size and structure onto a current collector of a negative electrode for a lithium metal battery; thus, the formation of lithium dendrites is effectively suppressed, cycle characteristics, a capacity retention rate, and rate capability are improved, and the silica layer has high specific area characteristics due to the precisely controlled pore size and structure.

An electrode for a lithium metal battery according to the present disclosure includes: a current collector; and a silica layer located on the current collector and containing plate-like porous silica, wherein pores of the plate-like porous silica have a cylindrical structure.

The silica layer contains a plurality of plate-like porous silica, and more specifically, the plurality of plate-like porous silica may be stacked in the silica layer. The cylindrical pores included in the plurality of plate-like porous silica having a stacked structure may be connected to each other to form a type of pore channel. As will be described below, when the battery is driven, lithium passes through the pore channel and is deposited on a surface of the current collector, and thus, dendrite growth may be suppressed.

In an exemplary embodiment, the electrode for a lithium metal battery may further include a lithium metal contained in the silica layer. Specifically, the lithium metal may be deposited on the silica layer by an electrochemical method. When the battery is charged, lithium in an ionic state moves through an electrolyte and is deposited on the electrode, and when the battery is discharged, the lithium metal may repeat reversible deposition and desorption based on the principle of lithium desorption from the electrode.

More specifically, the lithium metal may be deposited on the surface of the current collector. As a silica layer containing plate-like porous silica having precisely controlled pore size and structure has insulating properties, lithium is not deposited on the silica layer, and lithium may pass through the pores of the silica layer and may be deposited on the surface of the current collector having conductivity. As the lithium metal is deposited to a uniform thickness between the current collector and the silica layer without blocking the pores of the silica layer, the formation of lithium dendrites may be effectively suppressed.

A thickness of the silica layer may be 1 μm to 25 μm or 5 μm to 23 μm, and preferably 10 μm to 20 μm. In the above thickness range, the lithium metal is reversibly deposited on and desorbed from the surface of the current collector, and the form of the deposited lithium metal may be maintained without forming dendrites on the electrode surface even after repeated charging and discharging.

The plate-like porous silica may have pores having a cylindrical structure. As will be described below, when a size and length of the pores are controlled to be constant, lithium after passing through the pores is uniformly deposited on the surface of the current collector, such that lithium dendrites may be suppressed. In addition, since a path through which the lithium metal flows into the pores and reaches the current collector is short, a movement time is shortened, and therefore, the rate capability of the battery may be improved.

In an exemplary embodiment, the plate-like porous silica may have a hexagonal platelet structure. The hexagonal porous silica has a higher pore volume and aligned pore structure compared to cubic porous silica in the same volume and has a short pore length, which is advantageous for rapid adsorption and diffusion of materials.

In an exemplary embodiment, the plate-like porous silica may have mesopores having a diameter of 2 nm to 50 nm. More specifically, an average diameter of the cylindrical pores included in the silica layer may be 2 nm to 50 nm or 3 nm to 30 nm, and preferably 4 nm to 10 nm. In the above diameter range, the pores may not be blocked by the lithium metal. In addition, the length of the cylindrical pore may be 20 nm to 2,000 nm, 30 nm to 1,500 nm, or 50 nm to 1,000 nm, and advantageously, the length of the pore may be 50 nm to 300 nm so that the pores are uniformly aligned in a direction perpendicular to a plane to shorten the path through which lithium is deposited. Since lithium accumulates on the surface of the current collector located under the silica layer due to the pores having the above length range, there is an advantage that the lithium metal is not exposed on the silica layer.

More specifically, a ratio (V₁/V₂) of a mesopore volume (V₁) to a micropore volume (V₂) in the plate-like porous silica may be 50 to 200 or 70 to 170, and preferably 80 to 150. In the case of the micropores, which refer to pores having a diameter of 2 nm or less, it is difficult for the lithium metal to flow into the pores, there is a high risk of the pores being blocked by lithium, and a contact area between the current collector and the lithium metal may be reduced. Therefore, the silica layer contains the plate-like porous silica in which the volume of the mesopores is significantly larger than the volume of the micropores, such that the lithium metal is charged inside the electrode at a high speed with a high specific surface area, and at the same time, the pores are not blocked by the lithium metal, and the lithium metal is located between the current collector and the silica layer. As a result, the formation of dendrite structures may be suppressed.

In addition, a width of a pore size distribution ((D₉₀−D₁₀)/D₅₀) of the pores included in the plate-like porous silica may be 0.7 to 1.2 or 0.8 to 1.15, and preferably 0.9 to 1.1. As described above, when the pore sizes of the plurality of pores included in the plate-like porous silica are controlled to be constant, the lithium metal passes through the pores and is deposited on the surface of the current collector to a uniform thickness, and thus, the charge and discharge characteristics of the lithium metal battery may be improved.

In a specific example, in the electrode for a lithium metal battery, the silica layer may be formed by applying a slurry in which a plurality of plate-like porous silica are dispersed in a solvent onto a current collector. As a more preferred example, a slurry in which plate-like porous silica is dispersed may be applied onto a current collector using a coating device such as a doctor blade to which pressure is applied when discharging the slurry.

When the silica layer is formed using a doctor blade, the orientation of the plate-like porous silica contained in the slurry to be applied may be improved as a shear force is applied to the surface of the current collector. The silica layer containing the plate-like porous silica having improved orientation is advantageous because tortuosity of the pore channel may be reduced and the movement path through which the lithium metal is deposited on the surface of the current collector during charging and discharging may be shortened.

In an exemplary embodiment, the silica layer may further contain a binder. The binder may include a vinylidene fluoride/hexafluoropropylene copolymer (poly(vinylidene fluoride-co-hexafluoropropylene)), polyvinylidene fluoride (PVDF), polyacrylonitrile (PAN), poly(methyl methacrylate) (PMMA), polytetrafluoroethylene (PTFE), and a mixture thereof. In addition, the binder may include a styrene-butadiene rubber (SBR) polymer and the like, but the present disclosure is not limited by the specific type of binder.

The present disclosure includes a lithium metal battery including the electrode for a lithium metal battery described above. Since the materials, structure, shape, size, and the like of the electrode for a lithium metal battery included in the lithium metal battery are the same or similar to those described above, the lithium metal battery according to the present disclosure includes all the contents previously described in the electrode for a lithium metal battery.

The lithium metal battery according to the present disclosure includes: a negative electrode including the electrode for a lithium metal battery; a positive electrode disposed to face the negative electrode and to be spaced apart from the negative electrode; and an electrolyte filled between the negative electrode and the positive electrode.

As described above, as the silica layer containing plate-like porous silica is located on the current collector of the negative electrode, when the battery is driven, the lithium metal is uniformly deposited between the silica layer and the current collector, that is, under the silica layer and on the current collector, such that the formation of dendrites may be suppressed, thereby improving durability and long-term stability of the battery.

In addition, as the silica layer has high specific surface area characteristics by precisely controlling the pore size and structure of the plate-like porous silica, even though the lithium metal battery contains silica, which is an inert material, a reduction in energy density of the battery may be minimized, such that a lithium metal battery having a long-term lifespan and excellent rate capability may be implemented.

In a specific example, the positive electrode may contain a positive electrode active material, a conductive agent, and a binder. For example, the positive electrode active material may include LiCoO₂, LiMnₓO₂ₓ (x=1, 2), LiNi₁₋ₓMnxO₂ (0<x<1), LiNi_{1-x-y}CoₓMn_{y}O₂ (0≤x≤0.5, 0≤y≤0.5), or LiFePO₄, and more specifically may include a typical positive electrode active material capable of inserting and deintercalating lithium, such as LiMn₂O₄, LiCoO₂, LiNiO₂, LiFeO₂, LiFePO₄, V₂O₅, TiS, or MOS. Carbon black and graphite fine particles may be used as the conductive agent, and the binder may include a vinylidene fluoride/hexafluoropropylene copolymer (poly(vinylidene fluoride-co-hexafluoropropylene)), polyvinylidene fluoride (PVDF), polyacrylonitrile (PAN), poly(methyl methacrylate) (PMMA), polytetrafluoroethylene (PTFE), and a mixture thereof. Alternatively, the binder may include a styrene-butadiene rubber (SBR) polymer and the like. However, the present disclosure is not limited by the specific types of the positive electrode active material, conductive agent, and binder, and active materials, conductive binders, and binders commonly used in the lithium metal battery may be used.

The electrolyte may include an organic solvent and a lithium salt. Specifically, the organic solvent may include a carbonate-based compound, a glime-based compound, a dioxolane-based compound, an ether-based compound, or a combination thereof. More specifically, the organic solvent may include propylene carbonate (PC), ethylene carbonate (EC), fluoroethylene carbonate (FEC), diethyl carbonate (DEC), ethyl methyl carbonate (EMC), methyl propyl carbonate (MPC), butylene carbonate, benzonitrile, acetonitrile, tetrahydrofuran (THF), 2-methyltetrahydrofuran (2-MeTHF), γ-butyrolactone (GBL), dioxolane, 4-methyldioxolane, N,N-dimethylformamide (DMF), dimethylacetamide (DMAc), dimethyl sulfoxide (DMSO), 1,4-dioxane, 1,2-dimethoxyethane, sulfolane, 1,2-dichloroethane, chlorobenzene, nitrobenzene, dimethyl carbonate (DMC), methyl isopropyl carbonate, ethyl propyl carbonate (EPC), dipropyl carbonate (DPC), dibutyl carbonate (di-tert-butyl dicarbonate), diethylene glycol (DEG), dimethyl ether (DME), or a mixture thereof. The lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂) (C_{y}F_{2y+1}SO₂) (where x and y are natural numbers), LiCl, LiI, or a mixture thereof, but the present disclosure is not limited by the specific type of the electrolyte.

In an exemplary embodiment, the lithium metal battery may further include a separator interposed between the positive electrode and the negative electrode. The separator may be used without limitation as long as it is commonly used in the lithium metal battery. Specifically, it is preferable that the separator has low resistance to ionic movement in the electrolyte and excellent moisture retention ability of the electrolyte. For example, the separator may include glass fiber, polyester, polyethylene (PE), polypropylene (PP), polytetrafluoroethylene (PTFE), and a combination thereof.

Hereinafter, the present disclosure will be described in more detail with reference to Examples.

### Example 1

A first mixed solution was prepared by dissolving Pluronic P123 in a 2.0 M HCl solution containing 0.32 g of ZrOCl₂. The first mixed solution was stirred at 35° C. for 24 hours, 4.5 mL of tetraethyl orthosilicate (TEOS) was added, the mixed solution was additionally stirred for 1 hour, and then, ZrOCl₂ was added, thereby preparing a second mixed solution. The second mixed solution was transferred to a Teflon bottle and heated at 90° C. for 24 hours, and then, a solid product was filtered under vacuum and washed several times with distilled water, thereby obtaining a white reaction product. The reaction product was dried at 60° C., and then, the dried reaction product was heat-treated in an air atmosphere at 550° C. for 5 hours to remove residual P123 and other residual organic substances, thereby preparing plate-like porous silica. The plate-like porous silica was named platelet ordered mesoporous silica (pOMS).

95 wt % of the pOMS and 5 wt % of a polyvinylidene fluoride (PVDF) binder were added to an N-methyl-2-pyrrolidone (NMP) solvent, and then, mixing was performed with a thinky mixer rotating at 2,000 rpm, thereby preparing a slurry. The slurry was applied onto a Cu foil to a thickness of 14 μm using a doctor blade to form a silica layer, and then, drying was performed under vacuum at 80° C., thereby producing an electrode for a lithium metal battery.

### Comparative Example 1

A bare copper current collector without any treatment was used as an electrode for a lithium metal battery.

### Comparative Example 2

An electrode for a lithium metal battery was produced in the same manner as that of Example 1, except that a carbon layer containing plate-like porous carbon rather than a silica layer was formed on the copper current collector.

Specifically, the plate-like porous carbon was prepared as follows using the pOMS of Example 1 as a template. 1.0 g of the dried pOMS was mixed with 0.35 g of phenol, the mixture was heat-treated at 100° C. for 12 hours, and then, the mixture was reacted with paraformaldehyde at 160° C. for 8 hours, thereby producing a composite of a phenol/paraformaldehyde resin and pOMS. The composite was carbonized under an argon or nitrogen atmosphere at 900° C. for 6 hours. The carbonized composite was etched in a hydrofluoric acid solution diluted with 40 wt % of deionized water at room temperature for 12 hours to remove pOMS, and washed and dried at 80° C. overnight to prepare plate-like porous carbon from which pOMS was removed. The plate-like porous carbon was named platelet ordered mesoporous carbon (pOMC).

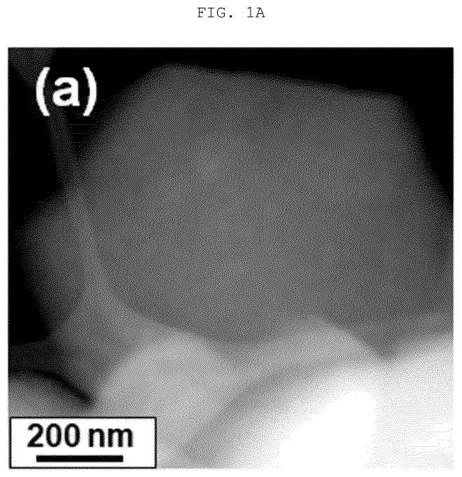

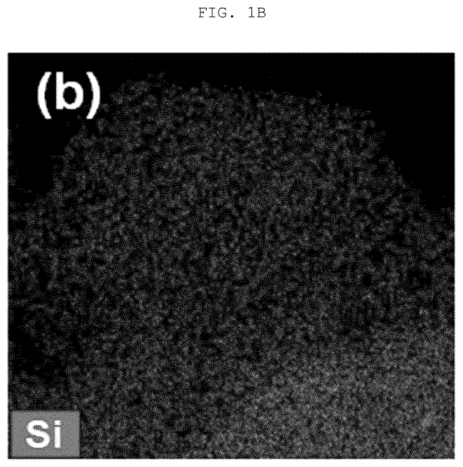

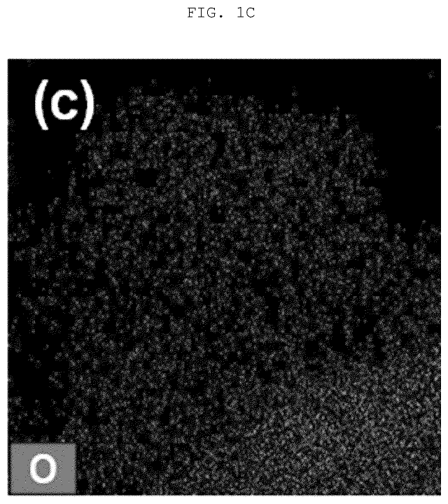

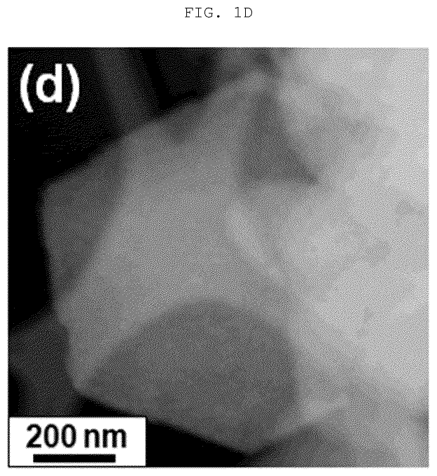

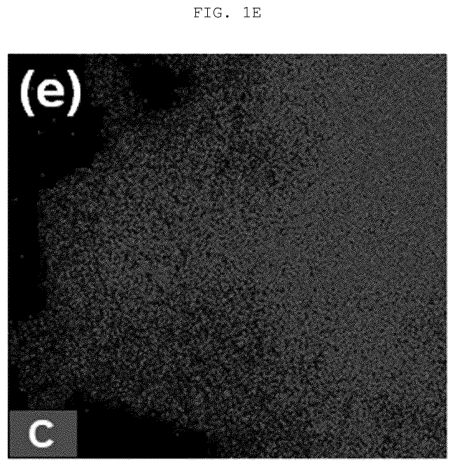

FIGS. 1A and 1D are high-angle annular dark-field scanning transmission electron microscope (HAADF-STEM) images of pOMS and pOMC, respectively, FIGS. 1B and 1C are EDS mapping images of the pOMS, and FIG. 1E is an EDS mapping image of the pOMC. EDS mapping was performed with a high-angle annular dark-field scanning transmission electron microscope (HAADF-STEM).

Through FIGS. 1A to 1C, it was confirmed that plate-like porous silica having a hexagonal structure was prepared. In addition, referring to the EDS mapping images of FIGS. 1B and 1C, it was found that silicon and oxygen were uniformly distributed throughout pOMS. In addition, as illustrated in FIGS. 1B and 1E, it was found that the pOMC prepared using pOMS as a template also had a shape corresponding to pOMS, and carbon was uniformly distributed throughout pOMC.

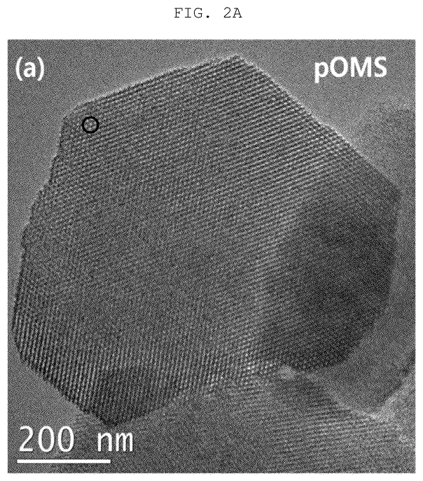

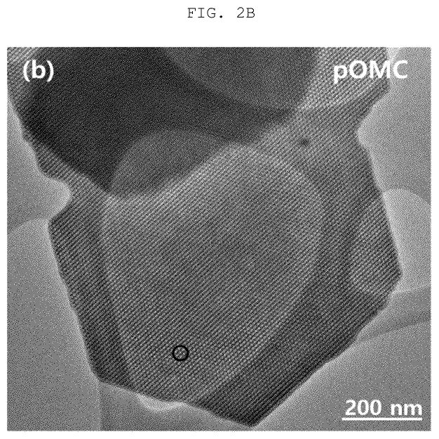

FIGS. 2A and 2B are transmission electron microscope (Tecnai G2 F20 TWIN TMP, FEI Co.) images of pOMS and pOMC, respectively. Referring to FIGS. 2A and 2B, it was found that pOMS and pOMC had a hexagonal platelet structure, and the mesopores had a uniform size and were highly developed. More specifically, referring to FIG. 2A, it was observed that a plurality of cylindrical mesopores included in pOMS were regularly distributed and the pores were uniformly aligned in a direction perpendicular to a plane. As the plurality of pores included in pOMS are aligned in the direction perpendicular to the plane, in the silica layer in which the plurality of pOMS are stacked, tortuosity of a pore channel is reduced, and thus, a movement path through which a lithium metal passes through the pores and is deposited on the surface of the current collector during charging and discharging may be shortened, which is advantageous.

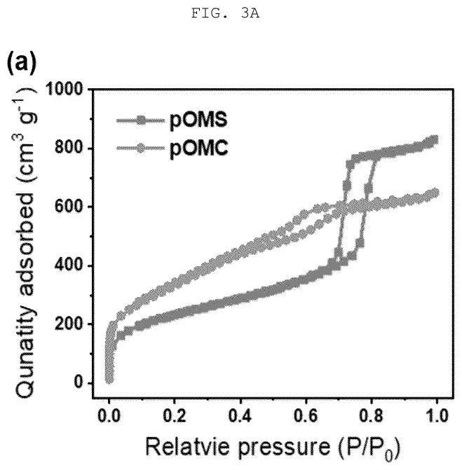

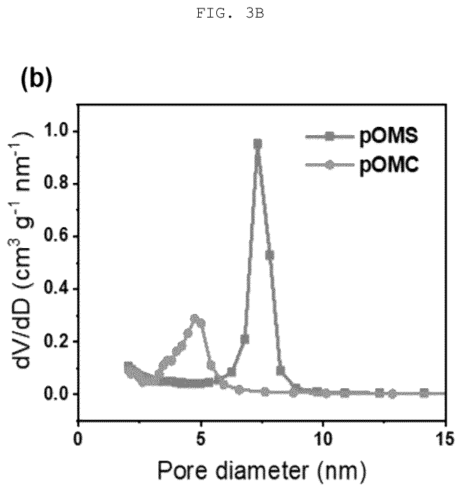

FIG. 3A is a graph showing nitrogen adsorption isotherms of pOMS and pOMC, and FIG. 3B is a graph showing pore size distributions of the pOMS and pOMC. The specific surface area and pore size distribution of each of the pOMS and pOMC were measured by performing Brunauer-Emmett-Teller (BET) adsorption-desorption method using an automated catalyst characterization system (AutoChem 2950 HP, Rigaku Co.).

Referring to FIGS. 3A and 3B, the specific surface areas of the pOMS and pOMC were measured to be significantly high at 843.8 m²/g and 1,224.1 m²/g, respectively, and the pore volumes of the pOMS and pOMC were measured to be 1.38 cm³/g and 1.28 cm³/g, respectively. In addition, the pOMS and pOMC showed significantly narrow widths of the pore size distributions centered on the pore sizes of 6.7 nm and 4.9 nm, respectively, confirming that the pore sizes were precisely controlled.

Therefore, through FIGS. 1A to 3B, it was confirmed that, by highly controlling the structure, pore size, and specific surface area of the plate-like porous silica, a silica layer optimized for suppressing the formation of lithium dendrites and improving the electrochemical performance of the battery described below was produced.

### (Experimental Example 1) Evaluation of Li∥Cu Battery Performance

A Li∥Cu battery was produced using each of the electrodes for a lithium metal battery produced by the methods of Example 1, Comparative Example 1, and Comparative Example 2 as a working electrode, and a lithium metal as a counter electrode. Specifically, in the Li∥Cu battery, polypropylene (Celgard 2400) was used as a separator, a mixture obtained by mixing 2 wt % of lithium nitrate (LiNO₃) with a mixed solution was used as an electrolyte, the mixed solution being obtained by mixing 1.0 M lithium bis(trifluoromethanesulfone)imide (LiTFSI) with 1,3-dioxolane (DOL) and 1,2-dimethoxyethane (DME) at a volume ratio of 1:1. The working electrode and the counter electrode were punched to diameters of 13 mm and 14 mm, respectively. The electrode for a lithium metal battery, the separator, and the lithium metal were sequentially stacked inside a glove box filled with argon (Ar) gas, and then, the electrolyte was injected, thereby producing a 2032-type Li∥Cu coin cell.

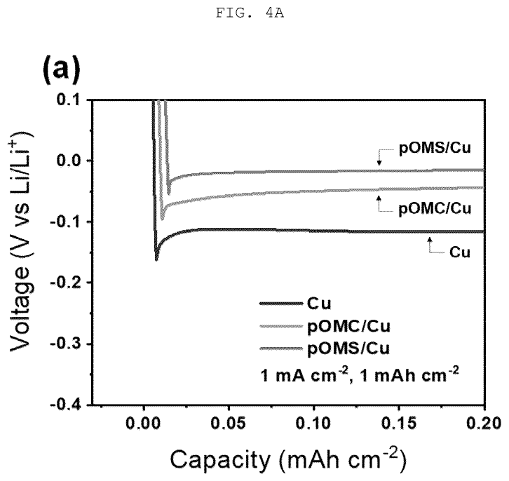

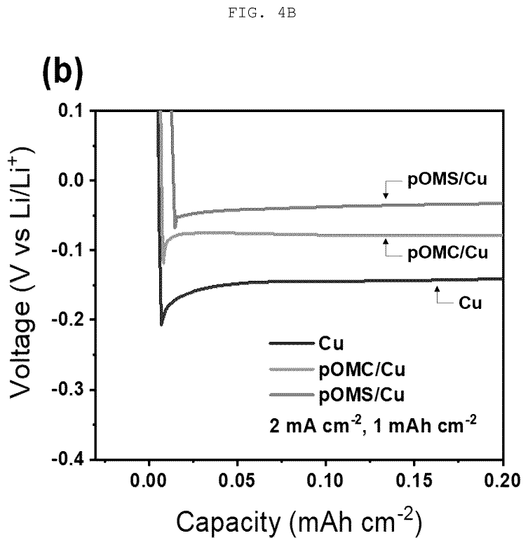

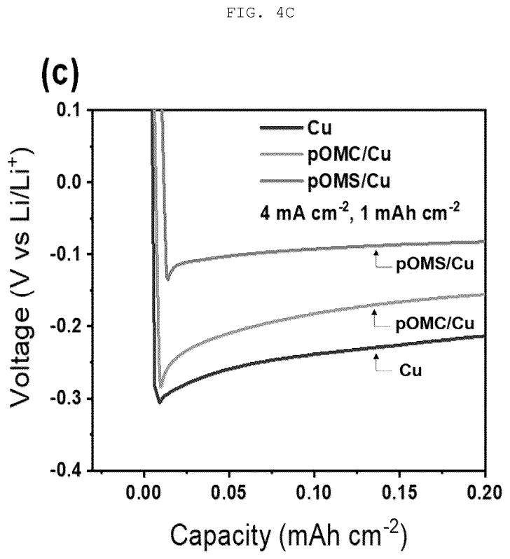

When the lithium metal was deposited on the surface of the copper current collector by applying a current to the Li∥Cu battery, overpotential according to the applied current density was measured through a galvanostatic charge and discharge experiment using a multi-channel battery tester available from WonATech Co., Ltd. The measurement results are illustrated in FIGS. 4A to 4C.

Specifically, FIGS. 4A, 4B, and 4C are graphs obtained by measuring the overpotential when lithium is deposited by applying different current densities of 1 mA/cm², 2 mA/cm², and 4 mA/cm², respectively, at a fixed capacity of 1 mAh/cm². At all the current densities, the lithium metal battery of Example 1 had the lowest initial overpotential, and therefore, lithium was stably deposited on the surface of the copper current collector. The lithium metal battery of Comparative Example 2 containing pOMC had a lower initial overpotential compared to the lithium metal battery using the bare copper current collector of Comparative Example 1 as a working electrode, but gradually showed more serious overpotential as the current density increased, and therefore, there were difficulties in lithium deposition.

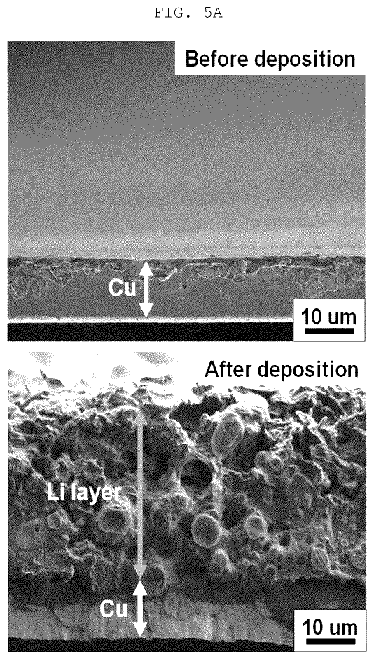

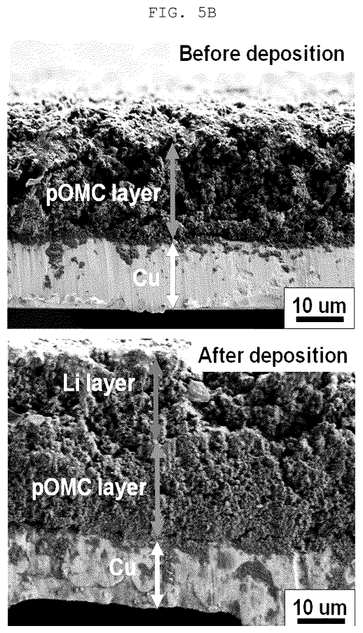

FIGS. 5A to 5C are scanning electron microscope (FE-SEM, SU4800, Hitachi, Ltd.) images obtained by observing cross sections of the electrodes before lithium deposition and after lithium deposition. Specifically, FIG. 5A is an SEM image obtained by observing the states before and after lithium deposition of the lithium metal battery using the electrode for a lithium metal battery produced by the method of Comparative Example 1 as a working electrode, FIG. 5B is an SEM image obtained by observing the states before and after lithium deposition of the lithium metal battery using the electrode for a lithium metal battery produced by the method of Comparative Example 2 as a working electrode, and FIG. 5C is an SEM image obtained by observing the states before and after lithium deposition of the lithium metal battery using the electrode for a lithium metal battery produced by the method of Example 1 as a working electrode.

Referring to FIGS. 5A to 5C, in the case of Comparative Example 1, the lithium metal was deposited on the copper current collector to a thickness of about 31 μm, and an irregular and rough surface was formed by lithium. In the case of Comparative Example 2, lithium was deposited on the carbon layer containing pOMC to a thickness of about 15 μm. After lithium was deposited, the total thickness of the lithium layer and the carbon layer was 33 μm, and the deposited lithium layer still showed an irregular shape.

On the other hand, in the case of Example 1 in which the silica layer containing pOMS was located on the copper current collector, lithium was deposited between the copper current collector and the silica layer to a thickness of about 13 μm, and the total thickness of the lithium layer and pOMS was 28 μm, showing that the lithium metal was uniformly deposited very thinly and compactly. It was confirmed that, as the lithium metal was very uniformly deposited between the silica layer and the copper current collector, lithium dendrites were significantly suppressed.

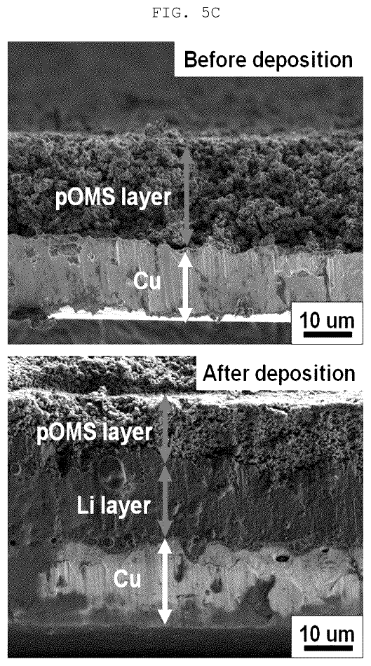

More specifically, FIG. 6 is a schematic diagram showing lithium metal deposition behavior on the copper current collectors for a lithium metal battery produced by the methods of Example 1 and Comparative Example 2. As illustrated in FIG. 6, in the case of Comparative Example 2 in which the carbon layer containing pOMC was located on the copper current collector, since the electrons were transferred through pOMC having excellent conductivity, lithium was not adsorbed inside the pores of the carbon layer, and the lithium metal was deposited non-uniformly and thickly on the carbon layer; thus, lithium dendrites were easily formed during repeated charging and discharging, causing the problems that a risk of battery damage was high and high overpotential occurred.

However, in the electrode of Example 1 in which the silica layer containing pOMS was located on the copper current collector, since the electrons did not pass through the silica layer having insulating properties, lithium passed through the pore channels of the silica layer, and the lithium metal was deposited thinly and densely between the copper current collector and the silica layer to a uniform thickness; thus, the formation of lithium dendrites was effectively suppressed when the battery was driven.

### (Experimental Example 2) Evaluation of Li∥Li Symmetric Battery Performance

A Li∥Li symmetric battery was produced using each of the electrodes for a lithium metal battery produced by the methods of Example 1, Comparative Example 1, and Comparative Example 2, and cycle performance thereof was evaluated.

Specifically, the electrodes for a lithium metal battery produced by the methods of Example 1, Comparative Example 1, and Comparative Example 2 were used by depositing lithium in advance under conditions of 0.1 mA/cm² and 4.2 mAh/cm². In the Li∥Li symmetric battery, polypropylene (Celgard 2400) was used as a separator, a mixture obtained by mixing 2 wt % of a lithium nitrate (LiNO₃) solution with a mixed solution was used as an electrolyte, the mixed solution being obtained by mixing 1.0 M lithium bis(trifluoromethanesulfone)imide (LiTFSI) with 1,3-dioxolane (DOL) and 1,2-dimethoxyethane (DME) at a volume ratio of 1:1. The negative electrode and the positive electrode were punched to diameters of 13 mm and 14 mm, respectively. The negative electrode, the separator, and the positive electrode were sequentially stacked inside a glove box filled with argon (Ar) gas, and then, the electrolyte was injected, thereby producing a 2032-type Li∥Li symmetric coin cell.

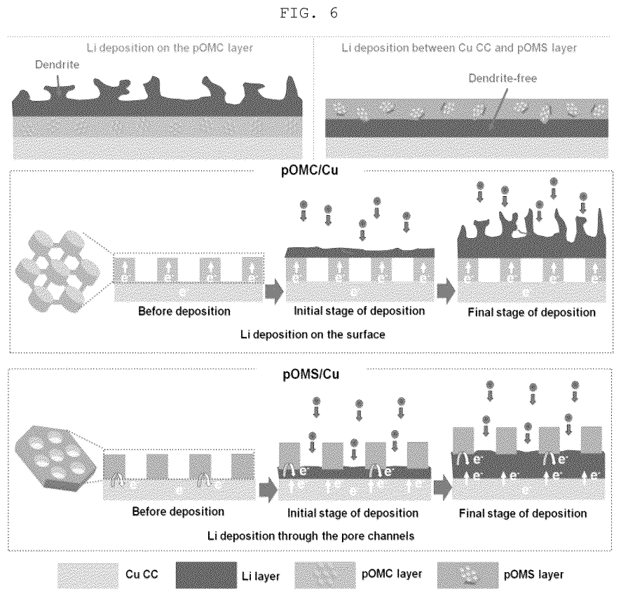

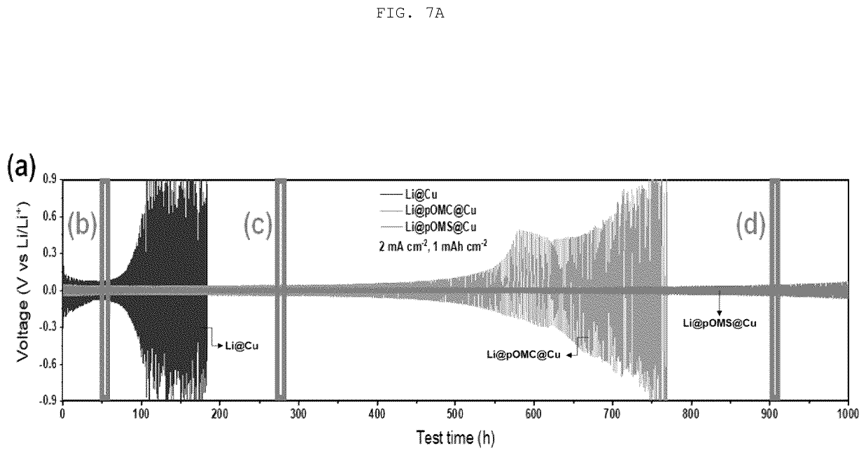

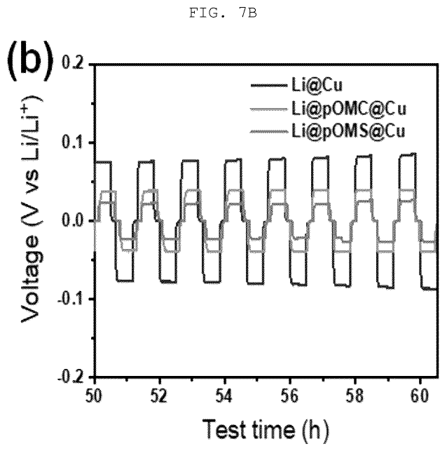

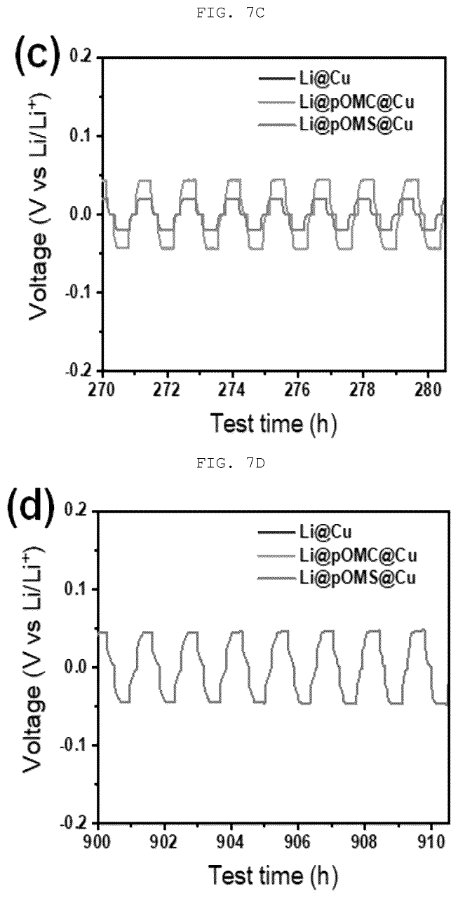

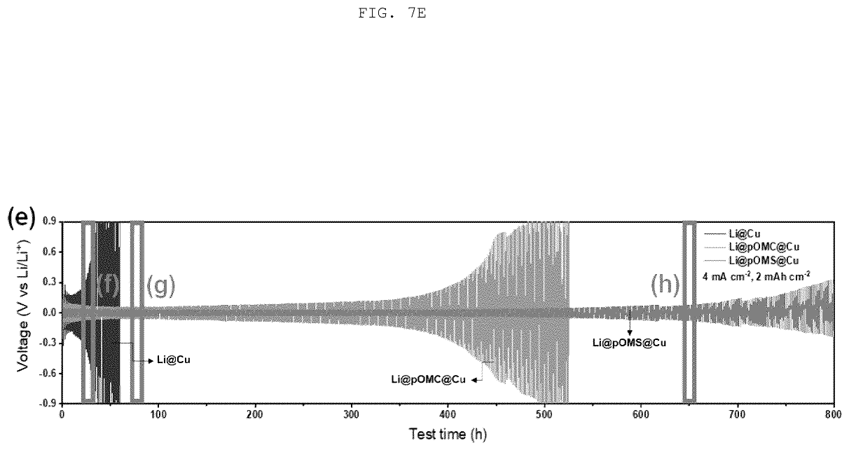

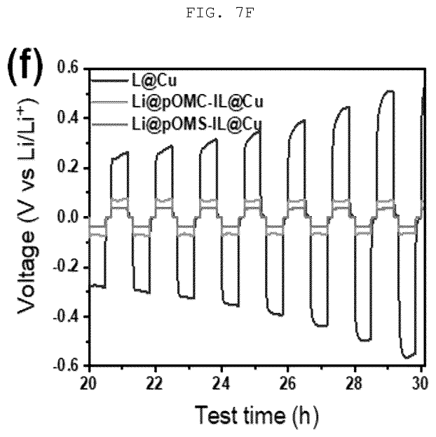

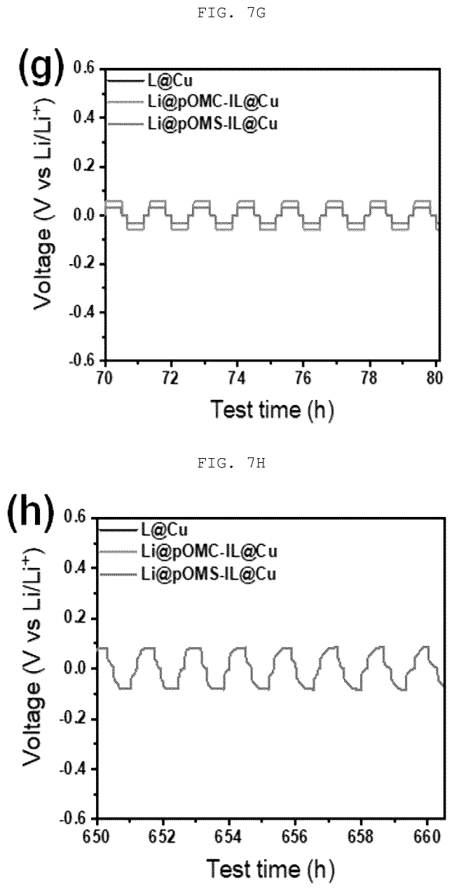

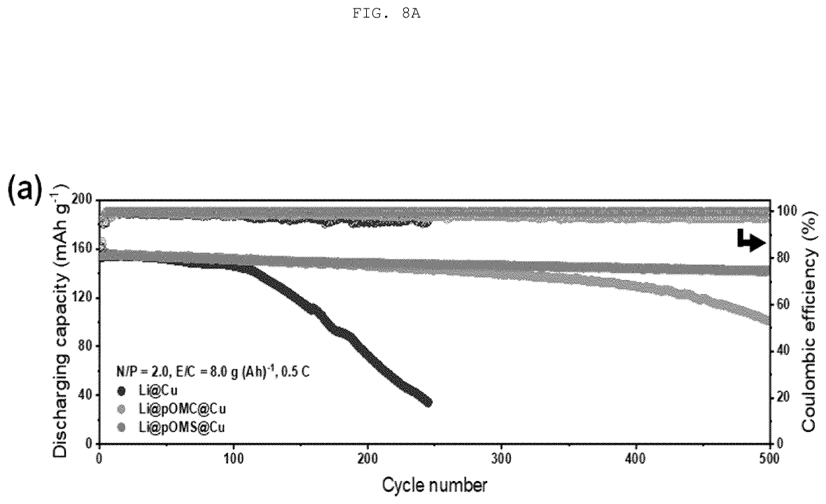

FIGS. 7A to 7D are graphs obtained by measuring cycle performance at a current density of 2 mA/cm² with a fixed capacity of 1 mAh/cm². As illustrated in FIGS. 7A to 7D, in the symmetric battery including the electrode for a lithium metal battery produced by each of the methods of Comparative Example 1 and Comparative Example 2, it was confirmed that the cell failed before 800 hours due to low cycle stability and a rapid change in overpotential compared to the initial voltage. Therefore, in the battery in which the negative electrode did not contain pOMS, it was confirmed that lithium was non-uniformly deposited on the surface of the negative electrode, and thus, active lithium and the electrolyte were excessively consumed, causing rapid deterioration of long-term stability.

On the other hand, in the symmetric battery using the electrode for a lithium metal battery produced by the method of Example 1 as a negative electrode, high cycle performance was maintained for 1,000 hours. Specifically, the overpotential value after the initial 50 to 60 hours was maintained until 270 to 280 hours had elapsed, and the symmetric battery was operated stably even after 1,000 hours.

Referring to FIGS. 7E to 7H illustrating the measurement results of the cycle performance under a 4 mA/cm² when the fixed capacity was 2 mAh/cm², the battery of Example 1 showed stable cycle characteristics for 800 hours even at a higher current density and capacity, and on the other hand, the batteries of Comparative Examples 1 and 2 had a problem in which cycle stability was seriously deteriorated at a high current density.

### (Experimental Example 3) Evaluation of Full Cell Performance

A Li∥NCM lithium metal battery was produced using the electrode for a lithium metal battery produced by each of the methods of Example 1, Comparative Example 1, and Comparative Example 2 as a negative electrode, and a positive electrode containing NCM as an active material, and long-term cycle performance thereof was measured.

Specifically, in the Li∥NCM battery, a slurry obtained by mixing 90 wt % of LiNi_{0.5}Co_{0.2}Mn_{0.3}O₂ (NCM) as an active material, 5 wt % of Super-P as a conductive agent, and 5 wt % of polyvinylidene fluoride (PVDF) as a binder with an N-methyl-2-pyrrolidone (NMP) solvent was applied onto an aluminum foil using a doctor blade. Thereafter, drying was performed in an oven at 100° C. for 2 hours, and the loading level and thickness were controlled using a roll press machine, thereby producing a positive electrode. The electrodes for a lithium metal battery produced by the methods of Example 1, Comparative Example 1, and Comparative Example 2 each were used as a negative electrode after depositing lithium in advance under conditions of 0.1 mA/cm² and 4.2 mAh/cm².

The negative electrode and the positive electrode were punched to diameters of 13 mm and 14 mm, respectively. The negative electrode, a polypropylene (Celgard 2400) separator, and the positive electrode were sequentially assembled inside a glove box filled with argon (Ar) gas, and then, an electrolyte containing a lithium nitrate (LiNO₃) solution containing 2 wt % of dimethyl carbonate (EMC) and a solution obtained by mixing 1 M lithium hexafluorophosphate (LiPF₆) and ethylene carbonate (EC) at a volume ratio of 3:7 was injected, thereby producing a 2032-type Li∥NCM coin cell.

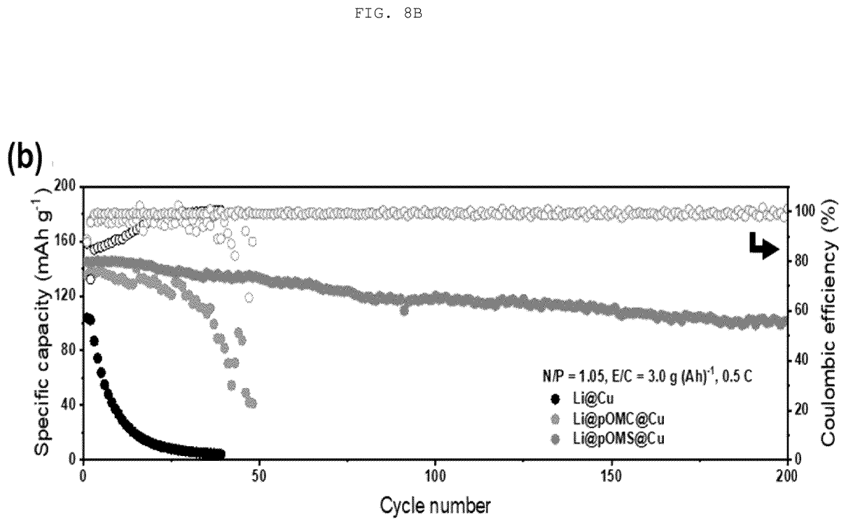

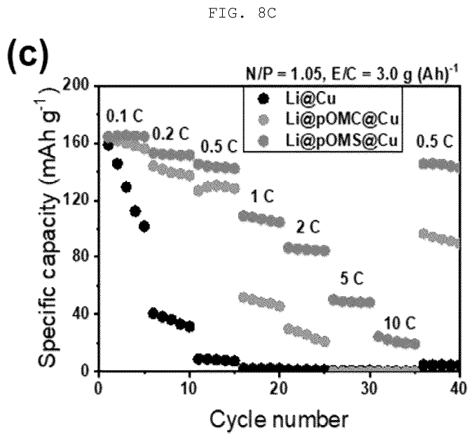

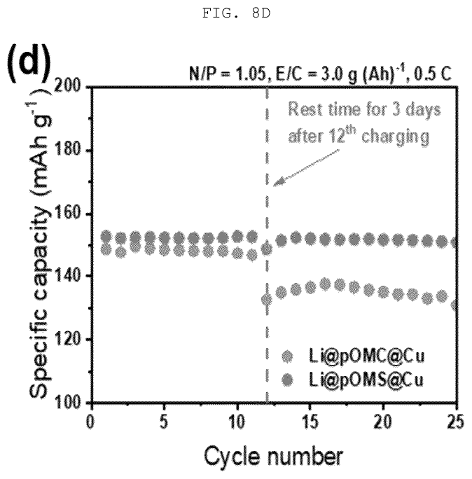

FIGS. 8A to 8D illustrate the long-term cycle performance evaluation results of the lithium metal batteries including the electrodes for a lithium metal battery of Example 1, Comparative Example 1, and Comparative Example 2 as negative electrodes. FIG. 8A is a graph obtained by measuring the cycle performance at a capacity ratio (N/P) of the negative electrode and the positive electrode of 2.0, a ratio (E/C) of the electrolyte amount and the negative electrode capacity of 8.0 (Ah)⁻¹, and 0.5 C, and FIGS. 8B to 8D are graphs obtained by measuring the cycle performance of the lithium metal batteries during 200 cycles at a capacity ratio (N/P) of the negative electrode and the positive electrode of 1.05, a ratio (E/C) of the electrolyte amount and the negative electrode capacity of 3.0 (Ah)⁻¹, and 0.5 C.

Referring to FIG. 8A, in the cases of the lithium metal batteries including the electrodes for a lithium metal battery produced by the methods of Example 1 and Comparative Example 2, in the first cycle, the discharge capacities were 155.8 mAh/g and 154.6 mAh/g, respectively, and the capacity retention rates after 500 cycles were measured to be 91.3% and 65.3%, respectively. In particular, the lithium metal battery including the electrode produced by the method of Comparative Example 1 stopped working within 250 cycles, but in the case of the lithium metal battery including the electrode produced by the method of Example 1, the initial capacity was maintained constant even after 500 cycles. Therefore, it was found that the lithium metal battery using the electrode produced by the method of Example 1 as a negative electrode showed a significantly high capacity retention rate even though it showed a similar initial capacity to those of the lithium metal batteries including the electrodes produced by the methods of Comparative Example 1 and Comparative Example 2.

Referring to FIG. 8B, in the lithium metal batteries including the electrodes produced by the methods of Comparative Example 1 and Comparative Example 2 as negative electrodes, the battery performance was rapidly deteriorated within 50 cycles, but in the lithium metal battery including the negative electrode produced by the method of Example 1, even after 200 cycles, the capacity retention rate was 70.3%, and the long-term stability was significantly improved by introducing the silica layer containing plate-like porous silica (pOMS) of the present disclosure.

FIG. 8C is a graph showing the results of measuring the rate capability of the lithium metal batteries including the electrodes produced by the methods of Example 1, Comparative Example 1, and Comparative Example 2 as negative electrodes. As illustrated in FIG. 8C, the capacity of each of the lithium metal batteries including the electrodes of Comparative Examples 1 and 2 rapidly decreased as the charge and discharge rate (C-rate) increased from 0.1 C to 10 C, and on the other hand, the capacity of the lithium metal battery including the electrode of Example 1 was stably maintained even at high current densities, showing that the rate capability was improved.

FIG. 8D is a graph obtained by measuring self-discharge behavior of the lithium metal batteries including the electrodes produced by the methods of Example 1 and Comparative Example 2 as negative electrodes. For the measurement of the self-discharge behavior, the lithium metal battery was charged and discharged at 0.5 C for 11 cycles, charged in the 12th cycle, and then rested for 3 days. Thereafter, the battery was discharged again and operated again from the 13th cycle to evaluate self-discharge behavior. As illustrated in FIG. 8D, in the case of the battery including the electrode of Comparative Example 2, a capacity loss of 9.6% occurred, and on the other hand, in the case of the battery including the electrode of Example 1, only a capacity loss of 2.6% occurred. That is, the silica layer containing pOMS prevented lithium from moving from the negative electrode to the positive electrode during the rest period, and thus, the loss in capacity was effectively prevented.

As set forth above, the electrode for a lithium metal battery may prevent the growth of lithium dendrites and may implement stable deposition of the lithium metal.

In addition, a loss in energy density per weight of the battery may be minimized by reducing the weight and volume of the functional material used to suppress lithium dendrites.

Furthermore, the lithium metal battery of the present disclosure may have improved long-term cycle performance and improved rate capability.

Hereinabove, although the present disclosure has been described by specific matters, limited exemplary embodiments, and drawings, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to the described exemplary embodiments, but the claims and all modifications equal or equivalent to the claims are intended to fall within the scope and spirit of the present disclosure.

What is claimed is:

1. An electrode for a lithium metal battery, the electrode comprising:
a current collector; and
a silica layer located on the current collector and containing plate-like porous silica,
wherein pores of the plate-like porous silica have a cylindrical structure.

2. The electrode of claim 1, wherein the silica layer is obtained by stacking a plurality of plate-like porous silica.

3. The electrode of claim 1, wherein the plate-like porous silica has cylindrical mesopores having a diameter of 2 nm to 50 nm.

4. The electrode of claim 3, wherein a ratio (V₁/V₂) of a mesopore volume (V₁) to a micropore volume (V₂) in the plate-like porous silica is 50 to 200.

5. The electrode of claim 1, wherein an average pore size of the cylindrical pores included in the plate-like porous silica is 4 nm to 20 nm.

6. The electrode of claim 1, wherein a length of the cylindrical pore included in the plate-like porous silica is 30 nm to 1,000 nm.

7. The electrode of claim 1, wherein the plate-like porous silica has a hexagonal platelet structure.

8. The electrode of claim 1, wherein a width of a pore size distribution ((D₉₀−D₁₀)/D₅₀) of the pores included in the plate-like porous silica is 0.8 to 1.2.

9. The electrode of claim 1, further comprising a lithium metal contained in the silica layer.

10. The electrode of claim 9, wherein the lithium metal is deposited by an electrochemical method.

11. The electrode of claim 1, wherein the silica layer further contains a binder.

12. A lithium metal battery comprising:
a negative electrode;
a positive electrode disposed to face the negative electrode and to be spaced apart from the negative electrode; and
an electrolyte filled between the negative electrode and the positive electrode,
wherein the negative electrode includes: a current collector and a silica layer located on the current collector and containing plate-like porous silica,
wherein pores of the plate-like porous silica have a cylindrical structure.

13. The lithium metal battery of claim 12, further comprising a separator interposed between the positive electrode and the negative electrode.
